(19) United States
(12) Patent Application Publication
(10) Pub. No.: US 2007/0043580 A1
(43) Pub. Date: Feb. 22, 2007

(54) Method and system for generating unique sequence numbers derived from zip codes for mail sorting

(75) Inventors: Kenneth G. Miller, Bethel, CT (US); Brian M. Romansky, Monroe, CT (US); Kwan C. Wong, Farmington, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 11/207,386

(22) Filed: Aug. 19, 2005

(51) Int. Cl. G06Q 99/00

(52) U.S. Cl. 705/1

(57) ABSTRACT

A method and system are provided for uniquely assigning identifications for a plurality of mail pieces, before physically sorting the mail pieces that will subsequently be mailed. Each of these identifications includes a sequential part, and each of the mail pieces includes postal destination information indicative of a destination area sort level. Preferably, not only that destination area sort level is included, but also at least one wider destination area sort level. The present invention entails determining whether a current mail piece has postal destination information indicative of the same destination area as a previously processed mail piece. If the destination area is the same, then the sequential part is assigned to the current mail piece, such that the sequential part is monotonically different from the sequential part of the previous mail pieces having the same destination area.

### TECHNICAL FIELD

The present invention relates to mailing systems, and more specifically to mailing systems that utilize manifests.

### BACKGROUND OF THE INVENTION

The United States Postal Service (USPS) has developed particular requirements for manifest mailing systems, and those requirements must be followed by mailers wishing to take advantage of lower mail rates. Likewise, some private carriers use similar systems that involve manifests.

A manifest mailing system (MMS) is a system for verifying postage payment. A mailer documents postage and fees for all outgoing pieces, and each piece is assigned a unique identification number that is listed on the manifest along with other pertinent information about each piece. The USPS then selects pieces at random for comparison with the manifest, in order to verify the accuracy of the manifest.

A keyline is typically printed on each mailpiece using batch processing. The keyline usually must contain: [1] a unique sequential piece number, [2] a weight for first class items, [3] a category for which the piece qualifies, and [4] the postage paid. So, for example, the keyline may read as follows:
5698 1 FP 0.296.

In this example, “5698” is the piece's sequential serial number [1]. “1” is the weight [2] in ounces. “FP” is the rate category [3]. And, “0.296” is the postage paid [4]. Note that the unique sequential piece number [1] is normally not allowed to be duplicated within the mailing. Moreover, the piece numbers [1] must normally be printed in ascending order, within each zone or area on the manifest list for a particular mailing.

A physical mail pre-sorter is often used to sort mail by zip codes, in order to group mail pieces in 3-digit or 5-digit zip codes. This pre-sorting is done, together with compilation of a manifest, in order to obtain the work-sharing discounts that the USPS makes available when it accepts a mailing. Each line in the manifest must, at a bare minimum, describe how to locate a mailing piece in the mailing, so that the USPS will be able to check that particular manifest entry if it so chooses. More specifically, the pieces must be marked sequentially, so that the USPS acceptance clerk will be able to locate each piece easily by looking it up in the manifest.

There are instances in which it would be very convenient for the sequence numbers to be assigned and printed on the mail pieces when the mail is produced, before the physical pre-sorting occurs. However, in such an instance, a simple scheme of assigning a sequence number such as 0001 to the first piece and 0002 to the second piece (et cetera) will not work once the mailpieces are physically sorted by zip code. In other words, a significant problem with these sequential piece numbers is that, after physically presorting the mail, this number would have no discernable sequence to it, thus making it very difficult for the USPS to verify the accuracy of the manifest.

This problem can be described by way of an example, in which the sequential numbers are assigned to each piece of mail when the mail is produced. Before physical pre-sorting, suppose there are nineteen pieces of mail with sequence numbers (and zip codes) as follows: 1200 (06484), 1201 (06484), 1202 (06484), 1203 (06484), 1204 (06484), 1205 (06481), 1206 (06481), 1207 (06481), 1208 (06484), 1209 (06484), 1210 (07104), 1211 (07205), 1212 (06483), 1213 (06483), 1214 (07205), 1215 (06483), 1216 (06482), 1217 (07104), 1218 (06482).

After physical presorting, the pieces are put into a very different arrangement, ordered according to zip code instead of sequence number: 1204 (06481), 1205 (06481), 1206 (06481), 1216 (06482), 1218 (06482), 1212 (06483), 1213 (06483), 1215 (06483), 1200 (06484), 1201 (06484), 1202 (06484), 1203 (06484), 1207 (06484), 1209 (06484), 1210 (07104), 1217 (07104), 1211 (07205), 1214 (07205). This problem with the prior art makes it very difficult for the USPS to confirm the accuracy of a manifest, which is necessary in order for a mailer to obtain discounts.

### SUMMARY OF THE INVENTION

The present invention discloses an algorithm that overcomes the problem of the prior art. This invention ensures that the sequence number assigned to each piece of mail will be properly ordered after the physical pre-sorting occurs, even if the sequence numbers are printed on the mail pieces prior to physical pre-sorting. Also, more than one sequential numbers can be printed in the keyline of each mailpiece, instead of just one sequential number.

According to this invention, pre-sort sequential numbers are tabulated and distributed in a sequential order for each destination area. A physical mail pre-sorter is then used to sort mail into presort schemes by zip codes to group mail pieces in 3-digit or 5-digit zip code sort levels. This is done, together with compilation of a manifest, in order to obtain the work-sharing discounts when a mailing is accepted by the USPS. To compile an itemized manifest, each line in the manifest must, at the minimum, describe how to locate a mailing piece in the mailing, and the pieces must be marked sequentially so that a postal acceptance clerk can locate each piece easily by looking it up in the manifest. Because there are instances requiring the sequence numbers to be assigned and printed on the mail pieces before physically pre-sorting, the present invention improves upon the typical scheme of assigning a sequence number such as 0001 to the first piece and 0002 to the second piece (et cetera), which will not work once the pieces are sorted by zip code. The present invention discloses an algorithm that overcomes this problem, so that the sequence number assigned to each piece will be properly ordered after physical sortation.

Instead of a typical prior art keyline 5698 1 FP 0.296, an example of the present invention's keyline will be 064845694 0645697 1 FP 0.296. In other words, the prior art sequential number 5698 is replaced by one or more new sequential numbers, such as 064845694 and 0645697. In this example, each new sequential number also provides zip code information in the keyline.

According to this invention, zip code information can be provided in the keyline with varying degrees of specificity, and for each degree of specificity the sequence numbers are indexed for particular zip code information. For example, suppose that we are concerned about a 3-digit sort level, and specifically the 3-digit zip code information “064.” For each additional item marked with this “064” in the keyline, a higher sequence number (e.g. 5697) will be assigned. Likewise, for each additional item marked with 5-digit zip code sort level information “06484,” a higher sequence number (e.g. 5694) will be assigned. In this way, the keyline may contain one or more sequence numbers, and those sequence numbers on a single mail piece may be different from each other (e.g. 5697 versus 5694). A third keyline sequence number can correspond to an additional anticipated sort level.

The method of the present invention is designed for uniquely assigning piece identification for mail pieces, such as information for the keylines of the mail pieces. The keyline of a single mail piece may be assigned more than one piece identification. This assigning process will occur before physically sorting the mail pieces, and that physical sorting will occur before the pieces are mailed. Each of the piece identifications comprises a sequential part, and each of the mail pieces includes postal destination information (e.g. a portion of a zip code) indicative of a destination area. The destination information may be included in one of the piece identifications, or it can be included elsewhere on the mail piece (e.g. in the address), or it can be included in both places. For instance, a full nine-digit zip code may be specified in the address on an envelope, whereas the keyline may merely indicate that the destination area is the area identified by the first three digits of the zip code for a 3-digit sort level. Thus, the destination information in this example would be partially in the keyline, but it could alternatively be located entirely in the keyline.

According to the present method, it is determined what sort levels mail needs to be physically presorted for. Next as mail is being processed determine whether a current mail piece (i.e. a mail piece currently being processed prior to physical pre-sorting) has postal destination area sort level information indicative of the same destination area of at least one previous mail piece that has already been processed. If the destination area sort level is the same, then a sequential part is assigned to the current mail piece that is monotonically different from the sequential part of the previous mail pieces having the same destination area sort level. Thus, the sequence numbers for this particular destination area sort level will progressively increase, or will progressively decrease. Typically, this monotonic change would be by increments of one.

### BRIEF DESCRIPTION OF THE DRAWINGS

FIG. 1 shows a flow chart for an embodiment of the present invention.

FIG. 2 is a block diagram of a system according to an embodiment of the present invention.

### BEST MODE FOR CARRYING OUT THE INVENTION

The present invention can be more fully understood by examining particular embodiments thereof. This will now be done, by way of illustration only, rather than in a limiting sense.

According to an embodiment of the present invention, the piece identification assigned to a mail piece, and appearing in the keyline of the piece, includes an indication of the destination area sort level. This area sort level indication is, in this embodiment, prefixed to a sequential part of the piece identification, and comprises at least two consecutive digits of a zip code. For example, the area indication may be the first three digits of the zip code, or alternatively the first five digits.

Preferably, the mail pieces have at least two sequential parts on each envelope, corresponding to at least two destination area sort levels, one of which is contained in the other. For example, the area corresponding to the first five digits of a zip code is contained in the area corresponding to the first three digits.

After the piece identifications are assigned, the mail pieces are physically sorted according to the destination information, and sorted mail having the same destination information will include the sequential parts in monotonic order, thanks to the manner in which those identifications were assigned prior to sorting. Those piece identifications are printed on the mail piece and also in a manifest. In this way, a USPS employee can identify an item on the manifest, then find the sorted mail pieces for the zip code area described in the manifest for that item, and easily find the sequentially numbered mail piece to which the manifest item refers.

It is important to recognize that zip code information in the keyline, such as “06484,” need not be the destination zip code for that particular mail piece. Instead, the number “06484” may, for example, be the lowest zip code of a scheme of 5-digit zip codes containing the destination zip code. In this example, the scheme is a set of three codes 06484, 06485, 06486; the destination zip code is any one of these three numbers, but only the lowest (06484) appears in the keyline. Of course, the algorithm of the present invention would work equally well if only the middle code (e.g. 06485) or the highest code (e.g. 06486) appears in the keyline.

It is important to bear in mind that the keyline may contain more than one sequential part (e.g. sequence number), each of which corresponds to zip code information having a different degree of specificity i.e. different sort level. This degree of specificity may, for example, be indicated by prefacing each sequence number with the relevant zip code information (e.g. 064845694 and 0645697), or by also prefacing each sequence number with an indicator of the degree of specificity (e.g. 5064845694 and 30645697).

Using more than one sequence number in each keyline prior to physical pre-sorting, as disclosed by the present invention, allows the sequence numbers to remain sequential after pre-sorting, regardless of whether a 3-digit pre-sort is performed, or a 5-digit pre-sort (or a 9-digit or some other type of pre-sort). This is a vast improvement over prior art systems in which a sequential arrangement cannot be maintained after one type of pre-sorting, much less after any of a plurality of types of pre-sorting.

The present invention's generation of sequence numbers is illustrated by the exemplary embodiment of the following tables. This first table shows how sequence numbers are assigned prior to physical pre-sorting. The bolded numbers refer to zip code information.

| | | | | Assigned | |
|---|---|---|---|---|---|
| | | | | Sequential | Assigned |
| | | | | # for 3- | Sequential |
| | | | | digit | # for 5-digit |
| | Mail Piece # | Zip Code | Action | Scheme | Scheme |
| 1 | 1 | 06484 | Read in first piece. | 306400001 | 50648400001 |
| | | | Initialize piece counts for | | |
| | | | 3-digit and 5-digit. Stores | | |
| | | | 064 and 06484. | | |
| 2 | 2 | 06484 | Search and find stored | 306400002 | 50648400002 |
| | | | 064 and 06484. | | |
| | | | Increment piece counts | | |
| | | | for 3-digit and 5-digit. | | |
| 3 | 3 | 06484 | Search and find 064 and | 306400003 | 50648400003 |
| | | | 06484. Increment piece | | |
| | | | counts for 3-digit and 5- | | |
| | | | digit. | | |
| 4 | 4 | 06484 | Search and find 064 and | 306400004 | 50648400004 |
| | | | 06484. Increment piece | | |
| | | | counts for 3-digit and 5- | | |
| | | | digit. | | |
| 5 | 5 | 06484 | Search and find 064 and | 306400005 | 50648400005 |
| | | | 06484. Increment piece | | |
| | | | counts for 3-digit and 5- | | |
| | | | digit. | | |
| 6 | 6 | 06481 | Search and find 064, but | 306400006 | 50648100001 |
| | | | not 06481. Store 06481. | | |
| | | | Increment 3-digit piece | | |
| | | | count and initialize 5-digit | | |
| | | | piece count. | | |
| 7 | 7 | 06481 | Search and find 0645 | 306400007 | 50648100002 |
| | | | and 06481. Increment | | |
| | | | piece counts for 3-digit | | |
| | | | and 5-digit. | | |
| 8 | 8 | 06484 | Search and find 064 and | 306400008 | 50648400006 |
| | | | 06484. Increment piece | | |
| | | | counts for 3-digit and 5- | | |
| | | | digit. | | |
| 9 | 9 | 06484 | Search and find 064 and | 306400009 | 50648400007 |
| | | | 06484. Increment piece | | |
| | | | counts for 3-digit and 5- | | |
| | | | digit. | | |
| 10 | 10 | 07104 | Search and can't find | 307100001 | 50710400001 |
| | | | 071 or 07104. Store 071 | | |
| | | | and 07104 and initialize | | |
| | | | piece counts. | | |
| 11 | 11 | 07205 | Search and can't find | 307200001 | 50720500001 |
| | | | 072 or 07205. Store 072 | | |
| | | | and 07205 and initialize | | |
| | | | piece counts. | | |
| 12 | 12 | 06483 | Search and find 064, but | 306400010 | 30648300001 |
| | | | not 06483. Store 06483. | | |
| | | | Increment 3-digit piece | | |
| | | | count and initialize 5-digit | | |
| | | | piece count. | | |
| 13 | 13 | 06483 | Search and find 064 and | 306400011 | 50648300002 |
| | | | 06483. Increment piece | | |
| | | | counts for 3-digit and 5- | | |
| | | | digit. | | |
| 14 | 14 | 07205 | Search and find 072 and | 307200002 | 50720500002 |
| | | | 07205. Increment piece | | |
| | | | counts for 3-digit and 5- | | |
| | | | digit. | | |
| 15 | 15 | 06483 | Search and find 064 and | 306400012 | 50648300002 |
| | | | 06483. Increment piece | | |
| | | | counts for 3-digit and 5- | | |
| | | | digit. | | |
| 16 | 16 | 06482 | Search and find 064 and | 306400013 | 50648100003 |
| | | | 06481. Increment piece | | |
| | | | counts for 3-digit and 5- | | |
| | | | digit. Note: 06481 and | | |
| | | | 06482 are in the same 5- | | |
| | | | digit scheme | | |
| 17 | 17 | 07104 | Search and find 071 and | 307100002 | 50710400002 |
| | | | 07104. Increment piece | | |
| | | | counts for 3-digit and 5- | | |
| | | | digit. | | |
| 18 | 18 | 06482 | Search and find 064 and | 306400014 | 50648100004 |
| | | | 06481. Increment piece | | |
| | | | counts for 3-digit and 5- | | |
| | | | digit. Note: 06481 and | | |
| | | | 06482 are in the same 5- | | |
| | | | digit scheme. | | |

After these 18 mail pieces are pre-sorted according to the first three zip code digits, they will have an arrangement shown by the following table.

| | | Assigned | Assigned |
|---|---|---|---|
| | | Sequential # for 3- | Sequential # for 5- |
| Mail Piece # | Zip Code | digit Scheme | digit Scheme |
| 1 | 06484 | 306400001 | 50648400001 |
| 2 | 06484 | 306400002 | 50648400002 |
| 3 | 06484 | 306400003 | 50648400003 |
| 4 | 06484 | 306400004 | 50648400004 |
| 5 | 06484 | 306400005 | 50648400005 |
| 6 | 06481 | 306400006 | 50648100001 |
| 7 | 06481 | 306400007 | 50648100002 |
| 8 | 06484 | 306400008 | 50648400006 |
| 9 | 06484 | 306400009 | 50648400007 |
| 12 | 06483 | 306400010 | 50648300001 |
| 13 | 06483 | 306400011 | 50648300002 |
| 15 | 06483 | 306400012 | 50648300003 |
| 16 | 06482 | 306400013 | 50648100003 |
| 18 | 06482 | 306400014 | 50648100004 |
| 10 | 07104 | 307100001 | 50710400001 |
| 17 | 07104 | 307100002 | 50710400002 |
| 11 | 07205 | 307200001 | 50720500001 |
| 14 | 07205 | 307200002 | 50720500002 |

Notice that, in the table above, the mail pieces for each three-digit code have incrementally increasing sequence numbers, whereas this is not true for the five-digit sequence numbers. Suppose instead that the mail pieces are physically pre-sorted according to the five-digit zip codes, as shown in the following table.

| | | Assigned | Assigned |
|---|---|---|---|
| | | Sequential # for 3- | Sequential # for 5- |
| Mail Piece # | Zip Code | digit Scheme | digit Scheme |
| 6 | 06481 | 306400006 | 50648100001 |
| 7 | 06481 | 306400007 | 50648100002 |
| 16 | 06482 | 306400013 | 50648100003 |
| 18 | 06482 | 306400014 | 50648100004 |
| 12 | 06483 | 306400010 | 50648300001 |
| 13 | 06483 | 306400011 | 50648300002 |
| 15 | 06483 | 306400012 | 50648300003 |
| 1 | 06484 | 306400001 | 50648400001 |
| 2 | 06484 | 306400002 | 50648400002 |
| 3 | 06484 | 306400003 | 50648400003 |
| 4 | 06484 | 306400004 | 50648400004 |
| 5 | 06484 | 306400005 | 50648400005 |
| 8 | 06484 | 306400008 | 50648400006 |
| 9 | 06484 | 306400009 | 50648400007 |
| 10 | 07104 | 307100001 | 50710400001 |
| 17 | 07104 | 307100002 | 50710400002 |
| 11 | 07205 | 307200001 | 50720500001 |
| 14 | 07205 | 307200002 | 50720500002 |

Notice that, in this last table, the mail pieces for each five-digit code have incrementally increasing sequence numbers, whereas this is not true for the three-digit sequence numbers. It is therefore clear from these tables that, after physically sorting the zip codes by 3 digits or 5 digits, the sequential numbers are properly ordered. Consequently, the work-sharing discounts will be preserved.

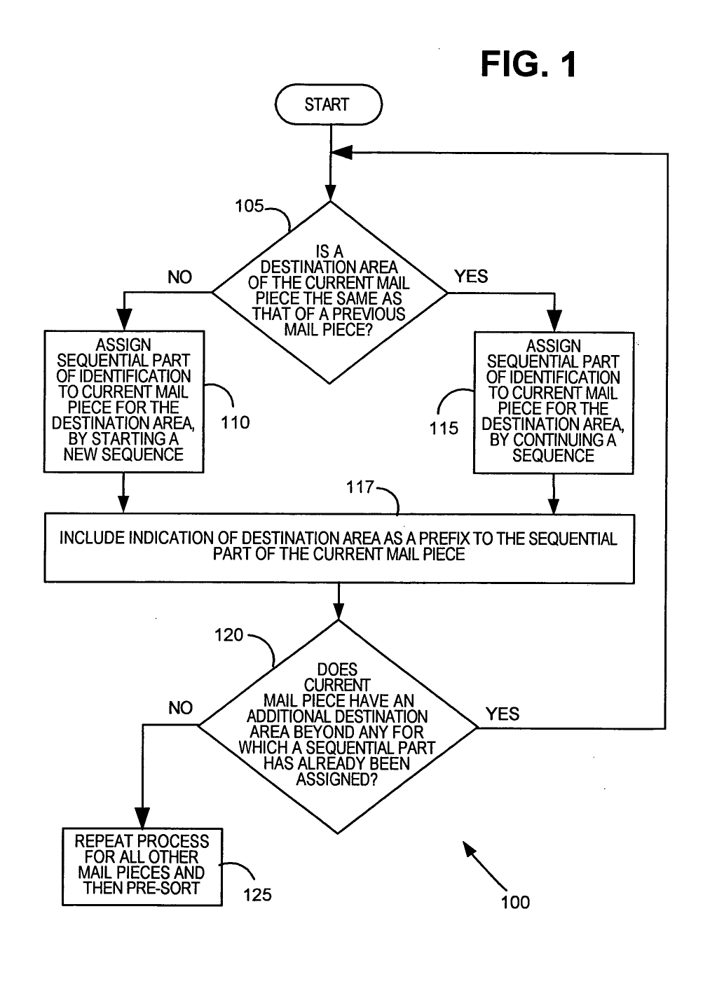

Referring now to the figures, FIG. 1 is a flow chart for an embodiment of the present invention. According to this method 100, a current mail piece is being processed, and previous mail pieces may have already been processed. A destination area sort level for the current mail piece is identified. The mail piece may have more than one such area sort level (e.g. both a larger and a small area in which the address is located). The question 105 must then be addressed as to whether or not the identified destination area sort level of the current mail piece is the same as a destination area sort level of a piece that has already been processed. If not, then a sequential part of the piece identification for the current piece is assigned 110 for that destination area, by starting a new sequence; for example, the sequential part may be 000 or 001. However, if the answer to the question 105 is yes, then the sequential part of the current piece's identification is assigned 115 by continuing the sequence of the previous mail pieces, for example by adding the number one.

Regardless of whether a new sequence is started for the current piece, or a sequence is continued for the current piece, once the sequential part is assigned then the destination area is indicated 117 by a prefix to the sequential part of the mail piece. Then, the question 120 must be addressed as to whether or not the current piece has an additional destination area beyond any for which a sequential part has already been assigned. For example, a sequential part may have already been assigned to the current piece for its zip code 06452, but not for the larger destination area denoted by 064. If the answer to this question is no, then the process 100 is repeated for all other mail pieces that have not been processed yet, and then the pre-sorting is performed 125. However, if the question 120 is answered affirmatively (i.e. the current mail piece has an additional destination area that has not yet been dealt with), then the process 100 is repeated for the current mail piece so that the additional destination area can be dealt with.

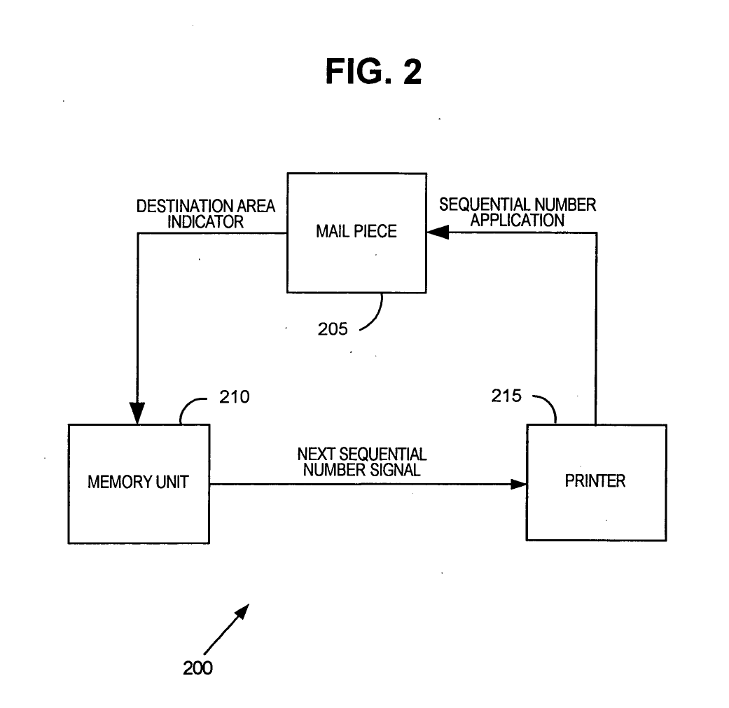

Referring now to FIG. 2, this shows a system 200 according to the present invention. A mail piece 205 is examined so as to provide an indication of a destination area, and this destination area indicator is provided to a memory unit 210. The memory unit helps to determine what the next sequence number is for that destination area, and provides that to a printer 215. The printer then prints the next sequence number on the mail piece 205. This arrangement is to be distinguished from the prior art, in which a printer simply prints successive sequence numbers on the mail pieces, without requiring any determination of what the next sequence number will be, and of course no memory unit was required to assist in such a determination. This present system, however, can be used effectively before pre-sorting, unlike the prior art systems.

It is to be understood that all of the present figures, and the accompanying narrative discussions of best mode embodiments, do not purport to be completely rigorous treatments of the methods and systems under consideration. A person skilled in the art will understand that the steps of the present application represent general cause-and-effect relationships that do not exclude intermediate interactions of various types, and will further understand that the various structures described in this application can be implemented by a variety of different combinations of hardware and software, and in various configurations which need not be further elaborated herein.

What is claimed is:

1. A method for uniquely assigning at least one piece identification for each of a plurality of mail pieces, before sorting the mail pieces that will subsequently be mailed, wherein each of the at least one piece identification comprises a sequential part, and wherein each of the plurality of the mail pieces includes postal destination information indicative of at least one destination area, comprising:
determining whether a current mail piece has postal destination information indicative of the same destination area as at least one previous mail piece, and
if the destination area is the same, then assigning said sequential part to the current mail piece wherein the sequential part is monotonically different from the sequential part of each of said at least one previous mail piece having the same destination area.

2. The method of claim 1, wherein the at least one piece identification includes an indication of the destination area.

3. The method of claim 2, wherein the indication of the destination area is a prefix of the sequential part.

4. The method of claim 1, wherein at least one of the mail pieces has at least two of said sequential parts corresponding to at least two destination areas, and wherein the at least two destination areas comprise a first destination area and also a second destination area that is contained by the first destination area.

5. The method of claim 1, wherein the sequential part is made monotonically different by adding one.

6. The method of claim 1, wherein the sequential part is made monotonically different by subtracting one.

7. The method of claim 2, wherein the indication of the destination area comprises at least two consecutive digits of a zip code.

8. The method of claim 4, wherein the first destination area and the second destination area are indicated in the at least one piece identification by a first part of a zip code and a second part of the zip code, and wherein the second part is a subset of the first part.

9. The method of claim 1, further comprising the step of sorting the mail pieces that will subsequently be mailed, wherein the mail pieces are sorted according to the destination information, and wherein sorted mail having the same destination information respectively includes the sequential parts in monotonic order.

10. The method of claim 9, further comprising the step of placing the at least one piece identification on the mail piece and also in a manifest.

11. A system for uniquely assigning at least one piece identification for each of a plurality of mail pieces, before sorting the mail pieces that will subsequently be mailed, wherein each of the at least one piece identification comprises a sequential part, and wherein each of the plurality of the mail pieces includes postal destination information indicative of at least one destination area, comprising:
a memory unit for determining whether previous mail pieces have postal destination information indicative of the same destination area as a current mail piece, and
a printer, for printing said sequential part on the current mail piece if the destination area is the same, wherein the sequential part is monotonically different from the sequential parts of said previous mail pieces having the same destination area.

12. The system of claim 11, wherein the at least one piece identification includes an indication of the destination area.

13. The system of claim 12, wherein the indication of the destination area is a prefix of the sequential part.

14. The system of claim 11, wherein at least one of the mail pieces has at least two of said sequential parts corresponding to at least two destination areas, and wherein the at least two destination areas comprise a first destination area and a second destination area contained by the first destination area.

15. The system of claim 11, wherein the sequential part is monotonically different by addition of the number one.

16. The system of claim 11, wherein the sequential part is monotonically different by subtraction of the number one.

17. The system of claim 12, wherein the indication of the destination area comprises at least two consecutive digits of a zip code.

18. The system of claim 14, wherein the first destination area and the second destination area are indicated in the at least one piece identification by a first part of a zip code and a second part of the zip code, and wherein the second part is a subset of the first part.

19. The system of claim 11, further comprising a sorter for sorting the mail pieces that will subsequently be mailed, wherein the sorter is for sorting the mail pieces according to the destination information, and wherein sorted mail having the same destination information respectively includes the sequential parts in monotonic order.

20. The system of claim 19, further comprising a manifest for listing the at least one piece identification.
